(19) United States
(12) Patent Application Publication
(10) Pub. No.: US 2017/0130754 A1
(43) Pub. Date: May 11, 2017

(54) Apparatus For Joining Cylindrical Members Having Internal Eccentric Connections

(71) Applicant: HARRIER TECHNOLOGIES, INC., GREENWICH, CT (US)

(72) Inventor: William Bruce Morrow, Santa Barbara, CA (US)

(21) Appl. No.: 14/506,740

(22) Filed: Oct. 6, 2014

Related U.S. Application Data
(60) Provisional application No. 61/888,106, filed on Oct. 8, 2013.

(51) Int. Cl. F16B 7/18

(52) U.S. Cl. CPC F16B 7/18

(57) ABSTRACT

A device for the threaded connection of tubular members, particularly as used in the petroleum industry, which provides both the full strength and near full internal diameter of typical oilfield tubular threaded connections, with the ability to securely join two cylindrical members with eccentric internal connections.

Applicant claims the benefits of provisional application Ser. No. 61/888,106, filed Oct. 8, 2013. The present invention introduces a novel structure for connecting cylindrical parts having internal, eccentrically positioned parts requiring engagement.

### BACKGROUND OF THE INVENTION

Field of the Invention

In a world where mechanization is state-of-the-art, various mechanical parts are necessarily connected with one another to create a path for the flow of energy, for example. Typical among such parts are cylindrical parts which, when connected, create a path for the uninterrupted flow of fluids, electricity, and other such elements.

For myriad reasons, the connection between cylindrical parts, even such parts which are of identical diameter, can be a difficult task. Not surprisingly, such connections can often be found at the point where access is severely limited and the ability to get a wrench or other tool on a connector is not only difficult, but in some instances, perhaps impossible.

Overview of the Prior Art

Joining cylindrical members, such as pipes or cylindrical housings, is usually done in one of three methods: flange connection, that is where a flange is formed or otherwise positioned at the connection point on the cylindrical members to be joined and then the flanges themselves are joined together. Also there may be a threaded connection, and, finally, the use of welds is used where it is safe to do so, and there is no need to get into the cylindrical members for maintenance and repair once they are joined.

However, if there are internal elements that must be joined, and those elements are not concentric within the cylindrical parts being joined, an obvious problem has been created. The prospect of using a threaded connection is obviously vitiated. Otherwise stated, if there are internal components, the connections of which are eccentric, relative rotation of the cylindrical members to be joined is not feasible, and use of a conventional threaded connection is not possible. In those cases, either a flange connection is used, or the two members are welded.

### SUMMARY OF THE INVENTION

As will become apparent from a reading of the detailed description of the present invention, it is a singular objective of the present invention to provide to industry a very simple and straightforward device for effecting a connection between cylindrical casings, or the like, including internal ports being also interconnected within very restricted and limited space.

It is a further objective of the present invention, related to the foregoing, to provide an effective seal between cylindrical parts in limited spaces, which seal is capable of being unsealed for maintenance, replacement or repair.

There are certain situations where the cylindrical members have a restricted outer diameter, such as oil field downhole assemblies, which usually must fit snugly within boreholes or casing, and a conventional external flange is not feasible. In these cases, an internal flange can be used. This type of flange is commonly used for oilfield downhole producing equipment. The disadvantage of such a flange connection is the significant restriction in inner diameter at the neck of the flange.

If the internal components of the members to be joined have eccentric connections require a greater inside diameter than allowed by the internal flange, one is forced to resort to a welded connection. However, welded connections may not be either feasible, due to temperature sensitivity of the equipment or components inside the housing, or desirable due to the resulting unit being of a greater length than can be easily handled. Welding also changes the metallurgy of the housing material, which can weaken it or make it more vulnerable to corrosion.

The present invention provides a method to securely join two cylindrical members via a threaded connection, while allowing the eccentric components connections.

### BRIEF DESCRIPTION OF THE DRAWINGS

FIG. 1 shows a cross-section through a typical internal flange connection between downhole components of an electrical centrifugal pump;

FIG. 2 is a perspective view of the ends of two cylindrical members to be joined, showing the eccentric location of components to be connected during the process;

FIG. 3 is a perspective side view of the same two cylindrical members in position to be joined;

FIG. 4 is a side view of the doubly threaded coupling, with a window in the coupling showing the internal threads;

FIG. 5 is a perspective side view of the doubly threaded coupling, showing the right-hand threads on the inside right surface of the coupling;

FIG. 6 is a perspective view of the two cylindrical members with the coupling (shown semi-transparent) positioned for joining the two members together;

FIG. 7 is a perspective view of the two cylindrical members nearly completely joined via the rotation of the doubly threaded coupling;

FIG. 8 is a perspective view of the two cylindrical members completely joined by the coupling;

FIG. 9 is a side view of the two cylindrical members partially connected, with a window in the threaded coupling revealing the position of the infernal components;

FIG. 10 is the same side view as shown in FIG. 9, with the two cylindrical members completely connected, with a window in the threaded coupling showing the final position of the internal components;

FIG. 11 is a perspective view of the ends of two cylindrical members to be joined, similar to FIG. 2, showing the O-ring sealing elements of each of the cylindrical members;

FIG. 12 is a side view of the doubly threaded coupling for joining the cylindrical members shown in FIG. 9, with a window in the threaded coupling revealing the position of the internal components;

FIG. 13 is a side view of the FIG. 11 embodiment showing the two cylindrical members partially connected, with a window in the threaded coupling revealing the position of the internal components;

FIG. 14 is the same side view as shown in FIG. 13, with the two cylindrical members completely connected, with a window in the threaded coupling showing the final position of the internal components;

FIG. 15 is a side view of two cylindrical members to be joined, where the outer diameters of the perspective members are not equal; and,

FIG. 16 shows the FIG. 15 embodiment fully connected, with a window in the threaded coupling showing the position of the threaded portion of the cylindrical members.

### DETAILED DESCRIPTION OF THE PREFERRED EMBODIMENT

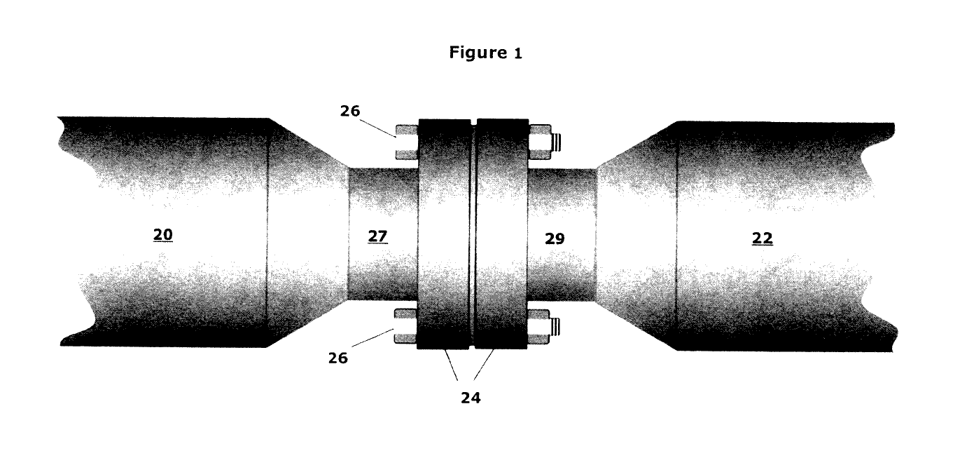

The present invention has a particular, although not exclusive, beneficial use for those in the oil patch. By way of example, there are many situations where cylindrical members to be joined have a restricted outer diameter due to limited space within a borehole or casing, and the use of a conventional external flange connection is not feasible. In these cases, an internal flange can be used. This type of flange, shown in FIG. 1, is commonly used for oilfield downhole producing equipment. The disadvantage of such a flange connection is the significant restriction in inner diameter at the neck of the flange.

If the internal components of the cylindrical members to be joined have eccentric connection, offset from the centerline of the cylindrical members, and require a greater internal diameter than allowed by the internal flange, oilfield workers today, until the advent of the present invention, have been forced to resort to a welded connection. However, welded connections may not be either feasible, due to temperature sensitivity of the equipment or components inside the housing, or desirable due to the resulting unit being of a greater length than can be easily handled. Welding also changes the metallurgy of the housing material, which can weaken it or make it to more vulnerable to corrosion.

FIG. 1 is a representation of a typical internal flange arrangement that is in current use in many production wells. Briefly, cylindrical members 20 and 22 are joined at flanges 24 and 25 by fasteners 26. Note the great restriction in the diameter of the connecting neck 27 and 29 between the two cylindrical members.

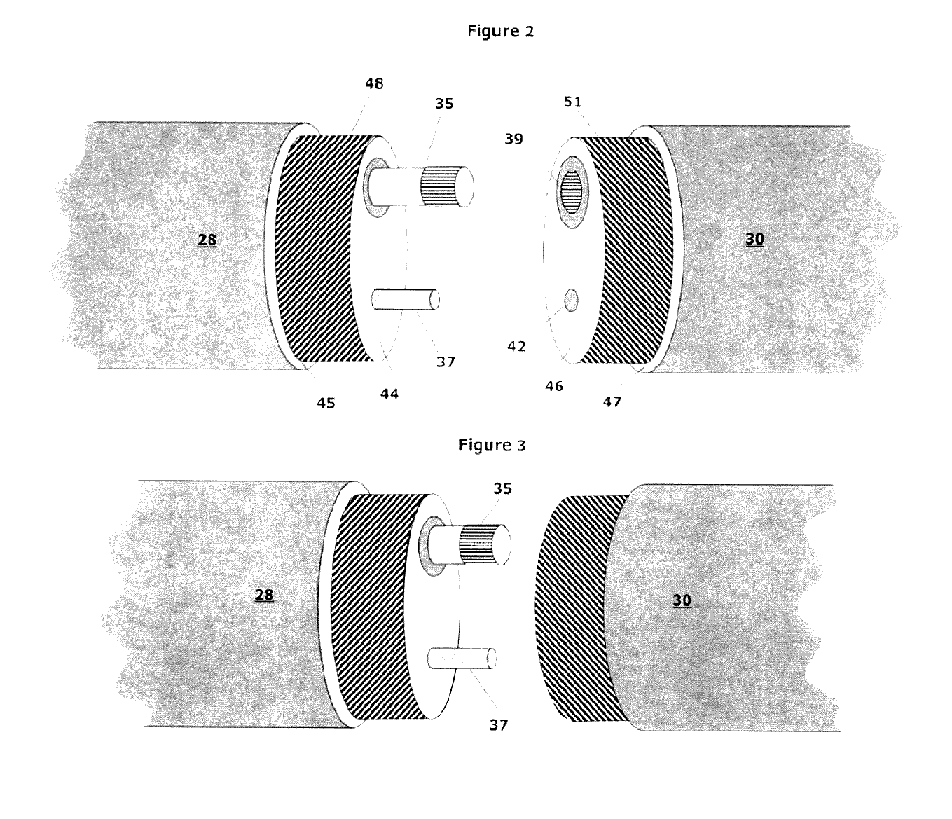

FIGS. 2 through 10 show, in stark contrast, the current invention. FIG. 2 shows the ends of two cylindrical members, 28, 30, to be joined, with the left hand member 28 clearly showing an eccentrically located, male splined shaft 35 and locating dowel 37, which are to mate with the female splined receptacle 39 and dowel bore 42, respectively, in the right hand member 30. Note that each of the two members has a cylindrical extension (44 left and 46 on the right) from the face of the member that is somewhat smaller in outer diameter than the rest of the member. The outer surface of these extensions is threaded, with the cylindrical extension 44 on the left member having a left-hand thread 48, and the cylindrical extension 46 on the right member having a right-hand thread 51.

FIG. 3 shows the two members lined up in preparation for joining.

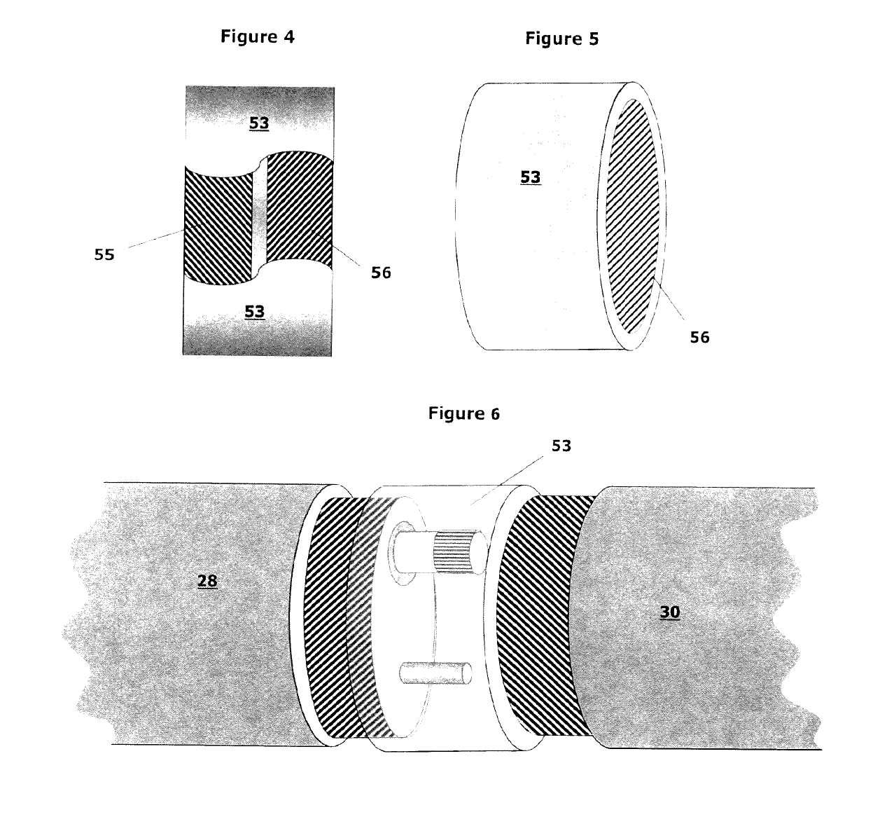

FIGS. 4 and 5 show an internally threaded female coupling 53. FIG. 4 shows a side view of the coupling, with a window in the coupling revealing the threads on the left inside surface 54 being left-handed, and those on the right inside surface 55 being right-handed. FIG. 5 is a perspective view of the coupling, showing the right hand female threads 55 on the inner surface of the right hand side.

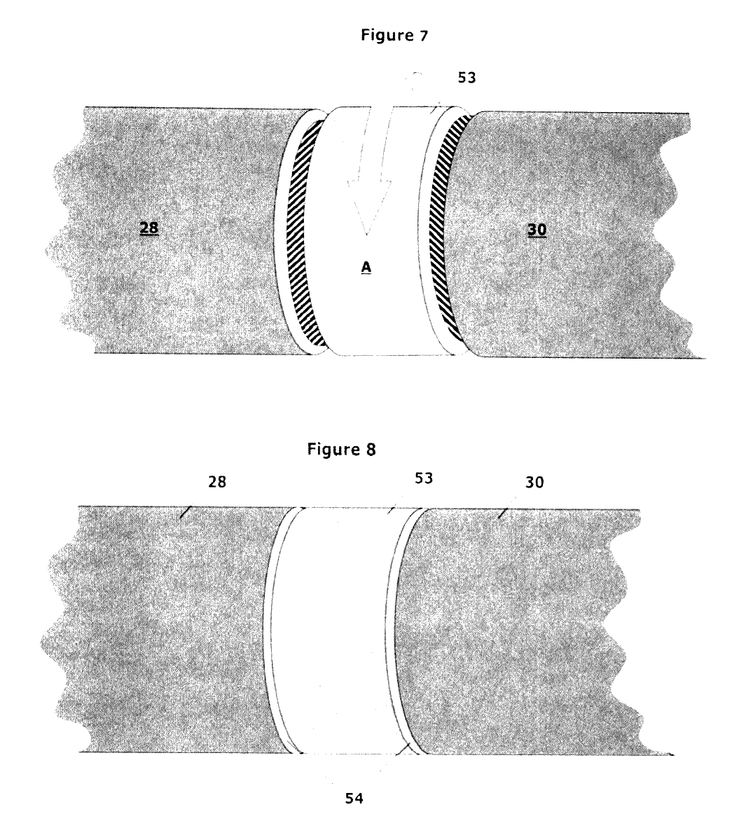

Moving to FIG. 6, the two members 28, 30 are positioned to be joined with the threaded female coupling 53 (shown semi-transparent) situated between them. The left and right cylindrical members are pushed together, engaging the female threaded coupling 53. The coupling, in keeping with the invention, is rotated as shown by arrow A in FIG. 7, thereby engaging the threaded extensions 48, 51 and pulling the two members together without requiring relative rotation of either member. This allows the splined shaft and locating dowel 37 to travel straight into the female splined receptacle 39 and dowel bore 42 as the members are drawn together by the rotation of the coupling, until the members seat firmly against one another as seen in FIG. 8.

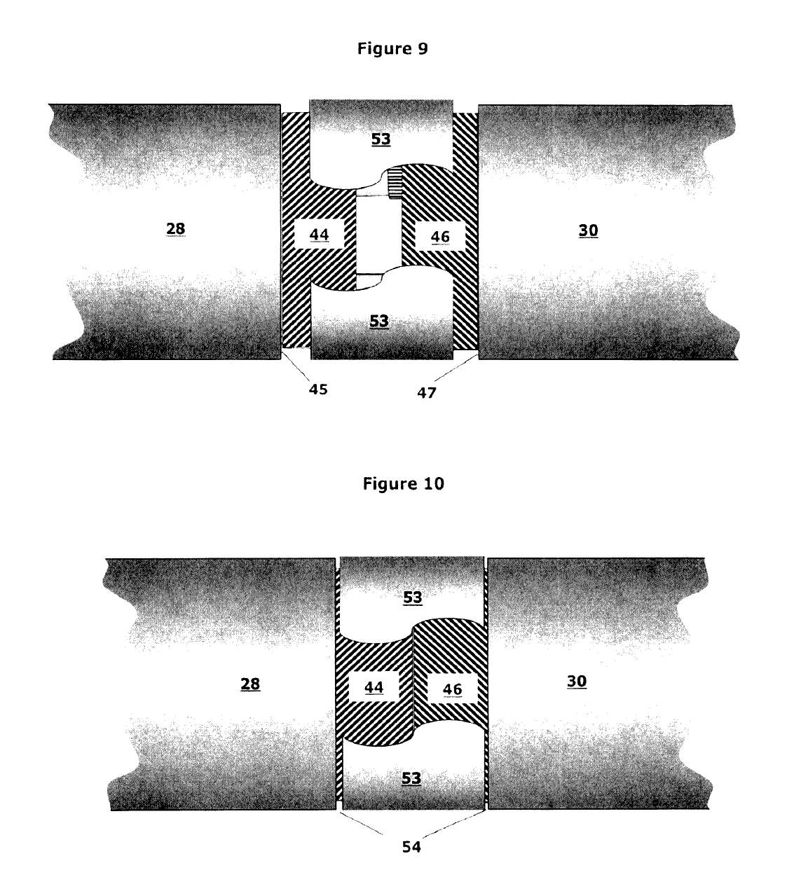

Note in FIG. 8, which shows cylindrical members 28 and 30 firmly connected via female coupling 53, there remains a gap 54 between the ends of the female coupling 53 and the edges 45 and 47 of the outer housings of cylindrical members 28 and 30. As the connection between cylindrical members 28 and 30 is made up, as shown in FIG. 7, the rotation of female coupling 53 draws the two cylindrical members 28 and 30 together, FIG. 9, until the inner faces of cylindrical extensions 44 and 46 contact and bear on one another, as seen in FIG. 10. At this point, female coupling 53 is tightened to the desired torque, and the connection is complete, This contact between the cylindrical extensions 44 and 46 occurs before the ends of female coupling 53 contacts the housing edges 45 and 47, leaving a gap 54. This is necessary to assure that the threaded connections between the female coupling 53 and the cylindrical extensions 44 and 46 are fully made up and evenly loaded.

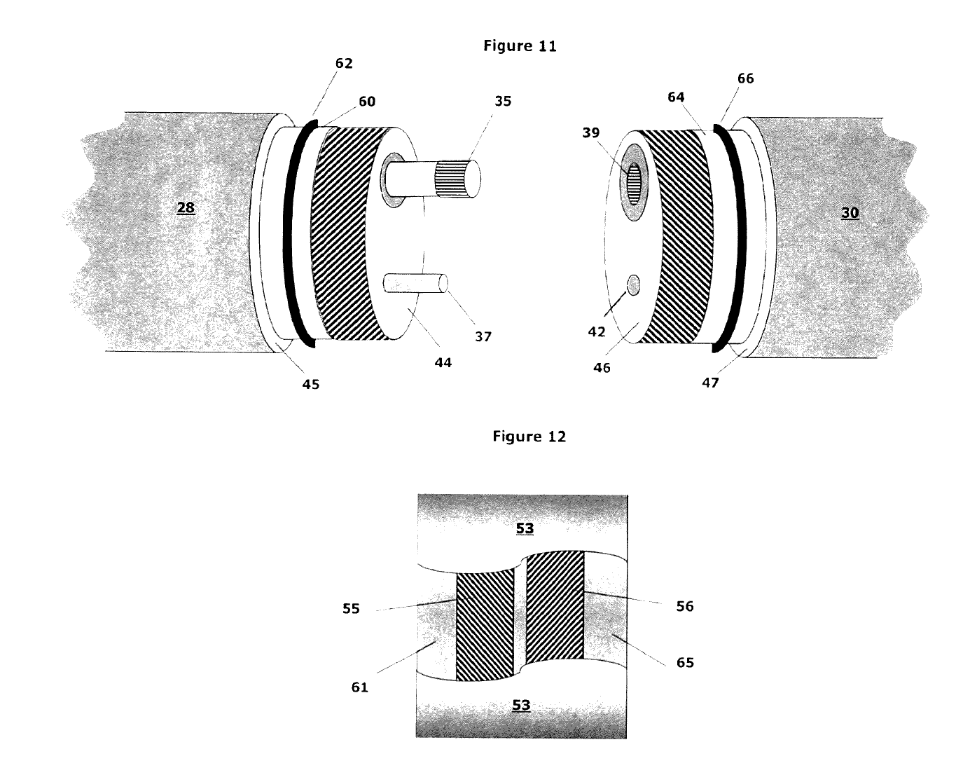

FIGS. 2 through 10 show the basic principle of the current invention. However, in practice, the resulting connection between cylindrical members 28 and 30 will almost always require some mechanism to effect a pressure and fluid entry seal between the external environment and the inside of the joined cylindrical members 28 and 30. FIGS. 11 and 12 show one commonly employed method to effect such a seal.

FIG. 11 shows the ends of the two cylindrical members 28 and 30, to be joined, as shown in FIG. 2, but with added sealing surfaces 60 and 64 outboard of the cylindrical extensions 44 and 46. Sealing surfaces 60 and 64 are shown with O-rings 62 and 66 placed in O-ring grooves (not shown) machined into the sealing surfaces of 60 and 64.

FIG. 12 shows a side view of the female coupling 53 adapted for the O-ring sealing of the connection between cylindrical members 28 and 30, with the window in the coupling revealing the threads on the left inside sealing surface 55 being left-handed, and those on the right inside sealing surface 56 being right-handed, and the female sealing surfaces 61 and 65, which fit snugly over the male sealing surfaces 60 and 64, effecting a seal with O-rings 62 and 66.

The two cylindrical members 28 and 30, show in FIG. 11, are joined via the internally threaded coupling 53 in the same manner as is shown in FIGS. 3, 6, 7, 8, and 10.

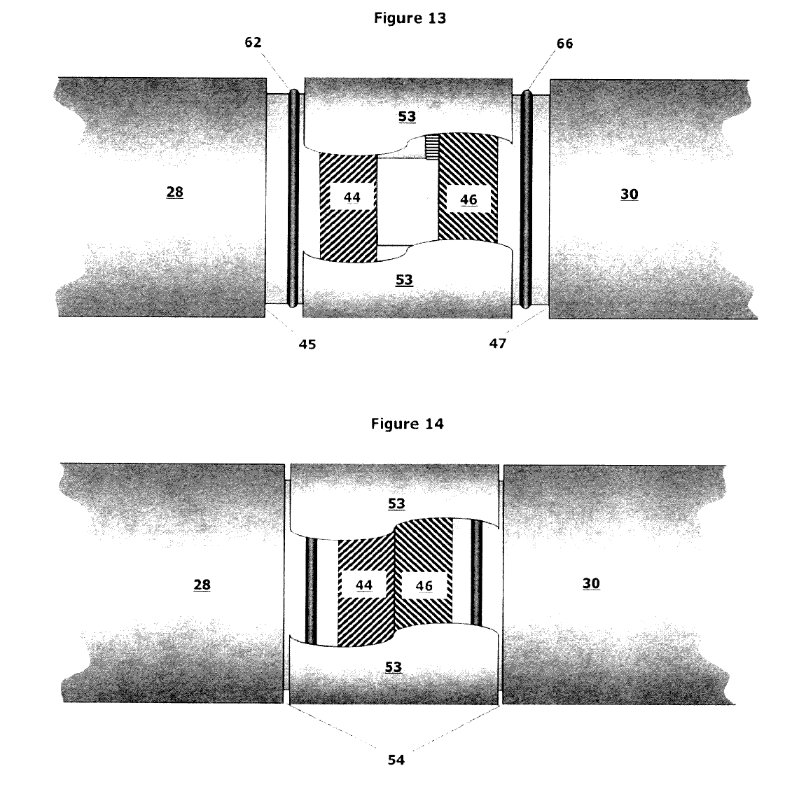

FIGS. 13 and 14 show the process of making up the connection between cylindrical members 28 and 30, similar to what is shown in FIGS. 9 and 10, with cylindrical members 28 and 30 drawn together by the rotation of female coupling 53 until the faces of cylindrical extensions 44 and 46 contact and bear against one another, leaving a gap 54 between female coupling 53 and the housing edges 45 and 47 of cylindrical members 28 and 30, respectively.

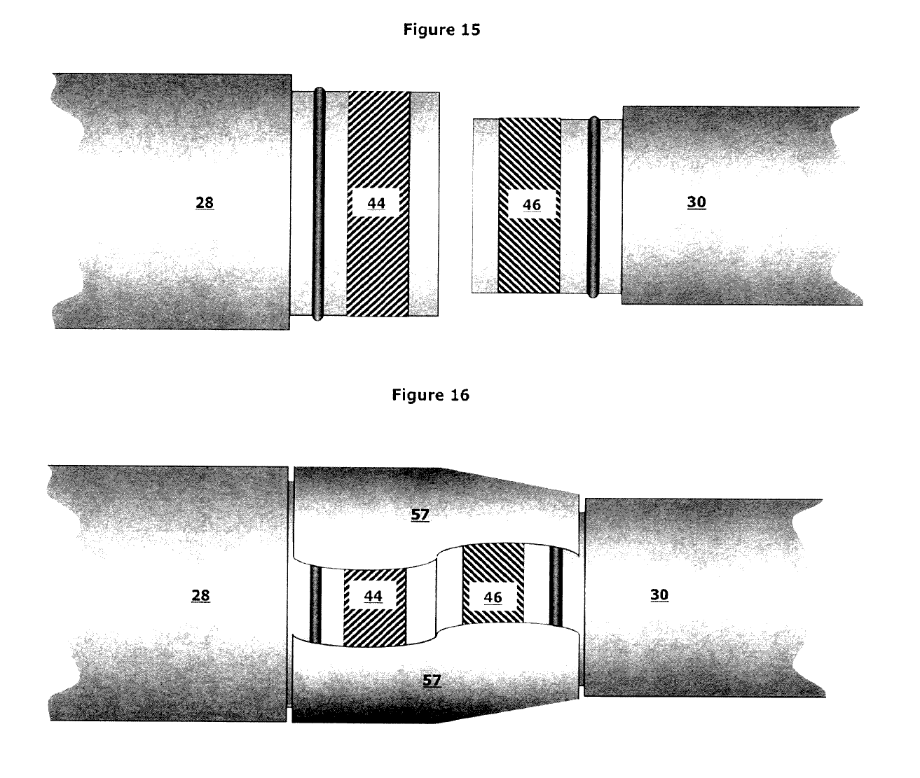

Although the current invention is particularly well suited for joining cylindrical members with offset internal components, the current invention can just as easily be used to join cylindrical members with concentric components, or bores, in lieu of the more conventional internally flanged or threaded connection. Also, the current invention can be utilized to join cylindrical members of different outside diameters by using a female coupling 57 adapted to the different threaded diameters, as shown in FIGS. 15 and 16.

It will be appreciated as well that those skilled in the art, upon reading this detailed description, may think of some variations in structure and form, such variations are within the contemplation of the invention as described and claimed in the following:

1. A coupling device to axially join cylindrical members, having a cylindrical coupling having an internal axial bore, and having two sets of female pipe threads cut into the surface of said bore, one set of pipe threads having a right-hand cut and the other having a left-hand cut;
two cylindrical members to be connected end to end, said members having a male threaded section on the outside surface of the ends to be connected, the threads of one member having a right-hand cut, and the threads of the other member having a left-hand cut;
wherein the diameter and pitch of the female threads cut into the inner bore of said coupling match that of the male threads cut into the outer surface of the said two cylindrical members to be joined;
said two cylindrical members being aligned axially with one another and with the coupling;
said right-hand male threaded end of one of the cylindrical members is inserted into the end of said coupling with the right-hand female thread cut into its inner bore surface, said threaded male and female surfaces partially engaged, and the left-hand male threaded end of the other cylindrical member is inserted into the end of said coupling with the left-hand female thread cut into its inner bore surface, said threaded male and female surfaces partially engaged;
said coupling being rotated in such a way as to more fully engage the threaded ends of the cylindrical members and draw them together, with the rotation continuing until the ends of the two cylindrical members contact one another within the coupling, and the required tightness of the connection is achieved.

2. The coupling device of claim 1, wherein said outer diameter of the cylindrical coupling is the same as the said principal outer diameters of the two cylindrical members;
said male threaded portion of the ends of the cylindrical members has a smaller outside diameter than said principal outside diameter of the cylindrical members, said smaller diameter matching the inside diameter of the threaded bore in said coupling such that said smaller male threaded ends made with said threaded inner bore of said coupling.

3. The coupling device of claim 1, wherein said cylindrical members have internal components eccentrically located relative to the principal axis of the member, said eccentrically located components of one cylindrical member requiring alignment with a mating eccentrically located component of the other cylindrical member during the connection of the two cylindrical members via said coupling.

4. The coupling device of claim 1, having a cylindrical coupling, said cylindrical coupling having an internal axial bore, having two sets of female pipe threads cut into the surface of said bore, one set of pipe threads having a right-hand cut and the other having a left-hand cut;
said coupling having at both ends a length of the bore surface between the outer edge of the coupling and the outer extent of said threads being smoothly finished;
two cylindrical member to be connected end to end, said cylindrical members having a male threaded section on the outside surface of the ends to be connected, the threads of one member having a right-hand cut, and the threads of the other member having a left-hand cut;
said outer surface of the cylindrical member outboard of said threaded section is smoothly finished;
said outer diameter of said smoothly finished surface of said cylindrical member is the same as the inside diameter of said smoothly finished portion of the inner is bore of said coupling; the respective said smooth surfaces of said cylindrical members and/or of said coupling are machined or otherwise equipped with an assembly such as an O-ring, or other similar device, to provide a pressure and fluid entry seal.

5. The coupling device of claim 1, wherein said cylindrical members have different outside principal diameters;
said cylindrical members having a male threaded section on the outside surface of the ends to be connected, the threaded section of one cylindrical member having a smaller outer diameter than that of the other cylindrical member;
said threads of one cylindrical member having a right-hand cut, and said threads of the other member having a left-hand cut, the threaded portions of both cylindrical members having the same pitch;
said cylindrical coupling having two co-axial internal bores of different diameters, one of said bores being equipped with right-hand pipe threads, and the other said bore being equipped with left-hand pipe threads, the diameter, pitch and sense of the threaded sections matching the male threaded sections of the cylindrical members.

6. The coupling device of claim 4, wherein said cylindrical members have different outside principal diameters.
